(19) United States
(12) Patent Application Publication
(10) Pub. No.: US 2024/0416395 A1
(43) Pub. Date: Dec. 19, 2024

(54) Apparatus For Fluidizing Particle Beds And Method Of Operating The Same

(71) Applicant: Rösler Holding GmbH, Bad Staffelstein (DE)

(72) Inventors: Till MERKEL, Neu-Ulm (DE); Moritz BECK, Bad Staffelstein (DE); Paul SIMON, Bischofsheim (DE); Christian ENDER, Großheirath/Rossach (DE); Domenik BRAUNROTH, Coburg (DE)

(21) Appl. No.: 18/621,210

(22) Filed: Mar. 29, 2024

(30) Foreign Application Priority Data
Mar. 30, 2023 (DE) 102023108230.2

(51) Int. Cl. B08B 7/02; B01F 31/60; B01F 35/00; B01F 35/214; B01F 35/222; B01F 35/75

(52) U.S. Cl. CPC B08B 7/02; B01F 31/60; B01F 35/188; B01F 35/214; B01F 35/222; B01F 35/75465

(57) ABSTRACT

An apparatus for fluidizing particles present as a particle bed and, optionally, objects included in the particle bed comprises at least one vertically movably supported container that defines a processing space for receiving the particle bed; an oscillation generator by which the container can be set into a vertical oscillation during operation; and a control unit for setting the frequency and/or amplitude of the vertical oscillation.

The invention relates to an apparatus for fluidizing particles present as a particle bed and to a method of operating the apparatus.

In chemical apparatus engineering, fixed beds flowed through by fluid are used for granular, medium to finely dispersed solids. For this purpose, a loose bulk is flowed through by a fluid, for example a gas. Depending on the flow velocity of the fluid, the bulk is present as a fixed bed, a homogeneous fluidized bed or an inhomogeneous fluidized bed. An increase in the gas velocity creates a so-called “slugging” fluidized bed, which then transitions into a turbulent fluidized bed, and finally the particles are discharged by the fluid flow (pneumatic conveying). However, a high mixing of the particles and the fluid is only possible with a high gas throughput. In particular in the case of finely dispersed particles (powders), dusts are discharged even at low flow velocities and must be removed from the gas flow downstream (e.g. by cyclones or filters). Furthermore, these processes are not suitable for the gentle treatment of larger agglomerates or objects embedded in the bulk. Rather, such bulks would segregate or the embedded objects would collide with the apparatus wall or with one another and would possibly be damaged.

Slide grinding techniques are used to process the surfaces of components made of metal, plastic, ceramic material or also wood. For this purpose, the components are embedded in moving bulks of abrasive bodies (for example, ceramic bodies or also plastic bodies with sizes between 1 mm and 100 mm in various geometries). The bulks are set into a rolling motion by vibrations so that the abrasive bodies process the surfaces of the embedded objects. In these processes, the bulk of the abrasive bodies is not set into motion or flowed through by fluids. In analogy to the fluidized bed systems, these moving bulks are in the state of a homogeneous bulk. The processing of components by the rollers of a moving bulk is only possible in the state of a homogeneous bulk. In contrast to the fluidized bed systems, an increase in the energy supply (for instance by vibration or rotation)-comparable to an increase in the gas velocity in the fluidized bed reactor-does not increase the mixing, but rather results in the processing roller collapsing. In such systems, no mobilization of the bed for processing embedded objects is therefore known that is comparable to the states that can be generated in a fluidized bed. Furthermore, the work containers, the abrasive bodies and the components must be set into motion in slide grinding technology. The high inertia of the masses in this respect indeed leads to stable processing conditions, but the excitation frequencies cannot be varied dynamically.

Thus, both technologies are not suitable for processing embedded larger objects in particle beds and for this reason also cannot be used for processing objects such as those produced by powder bed-based 3D printing. Today, such systems are typically handled in equipment in which the solid or loose powder beds with the objects embedded therein are subjected to compressed air and/or vibration. In this respect, the powder particles in the bed are loosened, mobilized and stirred up by injected fluids (for example, compressed air), extracted via vacuum systems or removed or discharged via openings in the system. The escaping gas volume flows include finely or very finely dispersed particles, which may lead to ignitable mixtures with some materials (plastic, titanium, magnesium). Very finely dispersed particles can be respirable and therefore harmful to health. Vibrations and high compressed air flows can furthermore cause embedded objects to interact intensively with walls and other objects and can thus damage them.

An object underlying the invention therefore comprises realizing a gentler fluidization of solid or loose particle beds without discharging particles and gases and damaging possibly embedded objects.

This object is satisfied by an apparatus having the features of claim 1.

The apparatus according to the invention comprises at least one vertically movable container that defines a processing space for receiving a particle bed. Furthermore, the apparatus comprises an oscillation generator, also called a vibration generator or an oscillator, by which the container can be set into a vertical oscillation during operation, and a control unit for setting the frequency and/or amplitude of the vertical oscillation. The apparatus enables a fluidization of beds without discharging particles or gases since it has surprisingly been found that a fluidized bed can be generated by a vertical oscillation even if only a small amount of fluid or even no fluid at all flows through the container. This therefore leads to an improvement in the work safety and to a very good mixing of the powder particles with one another and to a gentler separation of objects embedded in the powder that thus run less risk of being damaged. The invention is thus not only suitable for de-powdering objects, for example for separating an object additively manufactured by means of a powder bed-based 3D printing method from excess powder bed material, but also for a pure powder handling, such as the mixing, deagglomerating or conveying of powders.

The fluidization depends on the material, the filling height or the resulting surface weight (usually specified in g/cm²), the particle size, the packing density as well as the amplitude and frequency of the oscillation. For a given material with a given particle size and packing density, the apparatus according to the invention therefore makes it possible to achieve a desired fluidization of the bed by setting a suitable frequency, amplitude and/or filling height and to control the state of the fluidized bed produced.

In this context, the term “particles” refers to particles of a material that does not form a solid body with a defined geometric shape, in particular with a mean diameter in the micrometer range (1-2000 μm, preferably 1-1000 μm, more preferably 20-600 μm), which particles can, for example, be present as approximately spherical or irregularly shaped grains, whereas the term “objects” refers to macroscopic parts with a geometrically defined shape, which can result from a previous primary shaping, that in particular have a size in the millimeter or centimeter range (>1000 μm, preferably >2000 μm, more preferably >5000 μm).

Advantageous embodiments of the invention are described in the description, in the drawing and in the dependent claims.

The oscillation generator can be, for example, a vibration motor, a magnetic vibrator, a piston vibrator, a ball vibrator, a roller vibrator, a turbine vibrator or a structure-borne sound generator. The oscillation generator can be arranged below or to the side of the container. A plurality of oscillation generators can also be arranged below and/or to the side of the container.

In the present invention, the vertical oscillation is not limited to an oscillation that takes place substantially in the direction of gravity, i.e. perpendicular to a horizontal, even though an apparatus configured in this way is an advantageous embodiment of the present invention. In the present application, this term can also denote an oscillation that only has a vertical component, i.e. that takes place in a direction inclined to the horizontal plane.

The container can be attached to a base plate. In this respect, it is advantageous if the container and the base plate are flexibly connected to one another (e.g. via springs) since in this case only the container itself needs to be set into oscillation, whereas the base plate does not need to be moved. The base plate can be fixed in a horizontal position. However, the base plate can also be designed as inclinable. For example, an oscillation direction inclined to the horizontal can be realized.

The container preferably has a first opening, which is in particular at least partly closable, for introducing the particle bed and, optionally, objects included therein into the processing space. If the first opening is not closed in a complete and gas-tight manner, a gas exchange with the environment remains possible. If a cover is provided to close the first opening, the cover can be configured as partly closable, e.g. by segments provided in the cover or by a variable opening arranged in the cover. By setting the closed state, a counter-pressure can be built up and/or controlled in the processing space and the dynamics of the fluidized particle bed can thus be influenced. The closed state of the cover can in particular be controlled by the control unit. For example, the cover can have a variable opening whose degree of opening can be set by the control unit.

The container can additionally have a second opening, which is in particular closable, for removing material from the processing space. For example, the first opening can be arranged in an upper region and the second opening in a lower region of the container. Furthermore, a sieve unit can be provided in the region of the second opening, by means of which sieve unit the material removed from the container via the second opening is sieved. Furthermore, a scale can be provided by means of which the removed, sieved material can be weighed. According to one embodiment, the apparatus comprises a powder mixing unit that is in particular arranged below the container or, if a sieve unit is provided, is arranged below the sieve unit. The sieve unit, the scale and/or the powder mixing unit enable a preparation and reuse of the separated power and, if necessary, its mixing with a further powder immediately after the end of the process.

Alternatively or additionally, the mixing of several powders can take place in a separate mixing unit, which is configured as an apparatus according to the invention, to achieve a mixing via the fluidization and to benefit from the aforementioned advantages of the invention in this respect.

The apparatus preferably also comprises a suction unit connected to the container. The apparatus according to the invention generally makes it possible to achieve a fluidization of the particle bed through oscillations of the container even without a flowing fluid. Nevertheless, it can be advantageous if a suction unit is provided. The work safety can hereby in particular be increased since an undesired discharge of gases or particles from the container through the suction unit becomes less likely. The suction unit can be attached above, below or to the side of the container.

According to a further embodiment, a fluid supply connected to the container, in particular for supplying gas, is provided. Although, as mentioned, a fluidization of the particle bed is achieved according to the invention by oscillations of the container, it can nevertheless be advantageous to additionally introduce a fluid. Thus, an improvement in the fluidization process can be achieved if the container is flowed through by a small amount of fluid, in particular of gas, such as air, that would not be sufficient on its own, i.e. without oscillation of the container, for a fluidization, i.e. an exceeding of the loosening point, of the particle bed. In other words, the fluid volume flow can be set so that the particle bed does not loosen without oscillation of the container. Based on relevant known equations from chemical engineering textbooks, e.g. by means of the Ergun equation, a suitable fluid volume flow can be calculated using the parameters for characterizing the particle bed, such as the particle diameter, solid density, porosity of the bed, diameter, fill height, and the fluid flow, such as density, viscosity, fluid velocity. The fluid supply can be located above, below or to the side of the container.

In addition to or instead of the fluid supply for supplying a fluid to support the fluidization, such as compressed air, means for introducing a protective gas, such as nitrogen or argon, into the container or the processing space can also be provided. This allows the fluidization to be performed under an inert gas atmosphere, which is e.g. advantageous for the treatment of particle beds with oxidation-sensitive materials. According to a further advantageous embodiment, a vacuum source can be connected to the container. This allows the processing space to be evacuated before it is filled with shielding gas so that work can be carried out in an atmosphere that contains particularly little oxygen and other interfering substances, such as water vapor.

At least one wall of the container is preferably displaceable so that the volume of the processing space is changeable. It is further preferred that the base of the container is inclinable and/or is displaceable in a vertical direction. Furthermore, it is preferred if the container is configured such that the processing space can be tilted or inclined. These features have the effect that the processing space can be adapted to the processing parameters, for example with regard to the required filling level.

According to one embodiment, the processing space is configured as heatable and/or coolable. Thus, the process temperature can be optimized, for example with regard to the powder material to be processed.

It is preferred if the apparatus comprises a camera and/or a sensor for monitoring the processing space. The camera or the sensor can perceive process changes. The filling level of the container can, for example, be monitored by means of the camera or the sensor. A camera is particularly advantageous since it can, for example, record the fluidization process or display it in real time on a monitor.

The control unit can generally be suitable not only for setting the frequency and/or amplitude of the vertical oscillation, but also for data acquisition. If the apparatus has a camera and/or a sensor, the control unit can be connected to the camera or the sensor and can thus detect process changes. Furthermore, the control unit can be located in the camera, if one is present. The control unit can further be configured to make process adaptations, for example by changing the frequency, the amplitude and/or the level of a counter-pressure in the processing space, the latter for example by adapting a variable cover opening. The control unit can thus perform an automatic process adaptation based on data that are acquired by the camera and/or the sensor and forwarded to the control unit. The apparatus preferably furthermore comprises a non-volatile data memory that is connected to the control unit and that includes an internal parameter database in which process parameters are stored so that the control unit can access all the process parameters in the database.

According to one embodiment, the apparatus comprises at least one transport chute for transferring the particle bed and, optionally, objects embedded therein into the processing space and/or for outputting objects de-powdered in the processing space into an object output. Blow-off nozzles can be provided in the transport chute for an additional de-powdering of objects to be conveyed, e.g. by means of compressed air. Two different transport chutes can also be provided, of which one is provided for transferring the particle bed and, if necessary, the objects located therein and another is provided for outputting de-powdered objects into an object output.

A further subject of the invention is a method of operating the apparatus according to the invention, wherein the particles present as a particle bed and, optionally, objects embedded therein are converted into a fluidized bed by fluidization and energy required for this purpose is at least partly introduced via the oscillation generator in that the oscillation generator causes a vertical oscillation of the container whose frequency and amplitude are set by means of the control unit.

To prevent the discharge of particles or gases and to avoid damage to objects possibly included in the particle bed, it is preferred in this respect that the fluidization of the particle bed is caused solely by the oscillation and not by an introduction of a fluid into the container, that is, so-to-say takes place fluid-free. Nevertheless, according to another embodiment, it may also be advantageous to support the fluidization by an additional introduction of fluid, in particular of gas, such as air, into the container. In this respect, the container is, however, preferably only flowed through by such an amount of fluid that would not be sufficient on its own, i.e. without oscillation of the container, for a fluidization, i.e. an exceeding of the loosening point of the particle bed. In other words, the fluid volume flow can be set so that the particle bed does not yet loosen without the oscillation of the container. Based on relevant known equations from chemical engineering textbooks, e.g. by means of the Ergun equation, a suitable fluid volume flow can be calculated using the parameters for characterizing the particle bed, such as the particle diameter, solid density, porosity of the bed, diameter, fill height, and the fluid flow, such as the density, viscosity, fluid velocity. According to one embodiment, such a “gentle” fluid supply can also vary locally to realize different processing zones within a powder bed.

The fluidization can take place by converting the particle bed from a fixed bed into a homogeneous fluidized bed, from a homogeneous fluidized bed into an inhomogeneous fluidized bed, from an inhomogeneous fluidized bed into a turbulent fluidized bed and/or from an inhomogeneous fluidized bed into a slugging fluidized bed or in an ascending or descending order of these fluidized bed states. In this respect, the conversion of the particle bed into a slugging fluidized bed is preferred.

A relative movement between the particles and the objects occurs on the surface of any objects embedded in the fluidized bed. Due to the relative movement between the particles and the objects, adhesions are removed from the surfaces and/or the surface properties of the objects are changed.

According to one embodiment, the composition of the particles present as a bed is changed by removing or adding other particle types in order thus to intentionally influence the interaction between particles and objects. According to one embodiment, the additional powder can be an abrasive medium, which enables a surface treatment of objects included in the particle bed.

One or more powders can also be introduced into the container during the fluidization so that a subsequent metering or a powder mixing process takes place. Such a subsequent metering or powder mixing process can take place automatically, i.e. controlled by the control unit. The subsequent metering or powder mixing process, for example, takes place to mix different powder types, such as “used” and “fresh”, with one another, to adapt the powder properties with regard to moisture, particle size distribution, color, active components, conductivity, density, agglomerate content or other properties, or to modify the aggressive effect of a powder mixing in a subsequent process step.

The frequency of the vertical oscillation can be between 2 Hz and 200 Hz, preferably between 2 Hz and 100 Hz, more preferably between 10 Hz and 75 Hz. The amplitude of the vertical oscillation can be between 0.01 mm and 25 mm, preferably between 0.1 mm and 20 mm, more preferably between 0.4 mm and 12 mm. According to one embodiment example, the frequency is 50 Hz and the amplitude is 0.5 mm. According to a further embodiment example, the frequency is 18 Hz and the amplitude is 10.5 mm. It is possible to keep the amplitude, the frequency or both variables constant during the entire duration of the fluidization process. However, it can be advantageous to vary one or both of these variables over the time course of the process. For example, the frequency and/or the amplitude of the oscillation can be gradually increased at the start of the process until a respective maximum value is reached that is maintained for a certain time period. Similarly, before the end of the process, the frequency and/or the amplitude can, for example, be gradually reduced until they reach a value of zero.

In this way, abrupt changes can be avoided and different states in the fluidized bed (e.g. homogeneous fluidized bed, inhomogeneous fluidized bed, etc.) can be successively realized in a controlled manner.

If objects are included in the particle bed, they can be separated from particles by the method according to the invention. For example, the objects included in the particle bed can be freed from particles (e.g. powder residues) adhering to their surfaces. Such a removal of adhesions is also referred to as de-powdering in the present application.

If several objects with different weights are present in the particle bed, they can be sorted by weight or density in the vertical direction by the method according to the invention. The advantage therefore results that, as the result of the fluidization, objects can be found the higher up in the particle bed at the end of the process, the smaller and lighter they are and can be found the further down in the particle bed, the larger and heavier they are.

According to a preferred embodiment, the amplitude and/or the frequency of the oscillation are set so that some or all of the objects included in the particle bed float on the fluidized particle bed. The container can also be filled with a medium that has a greater density than the objects to keep them on the surface by buoyancy. If the objects are on the surface of the particle bed, they can be particularly easily removed from the container.

According to a particularly advantageous embodiment of the method according to the invention, the objects are additively manufactured objects from a powder bed-based 3D printing method and the particle bed comprises a powder cake composed of excess material of the 3D printing method. The 3D printing method can be any desired powder bed-based method, such as SLS (selective laser sintering), MJF (multi-jet fusion), SAF (selective absorption fusing) or binder jetting.

In the field of powder bed-based 3D printing, there is generally the problem that the powder bed used is not completely processed into additively manufactured objects, but that the objects, immediately after their creation, are initially enclosed in a powder cake made of powder bed residues. The manufactured objects must be freed (“unpacked”) from this powder cake. It has been found that the apparatus and the method according to the present invention are excellently suited to separating objects additively manufactured by such a method from the surrounding powder cake.

It is furthermore a common problem of powder bed-based 3D printing methods that the objects manufactured in this way often have large amounts of powder adhering to them (so-called “potatoes”). Known de-powdering methods for removing the adhesions, e.g. by means of compressed air or vibration, have several disadvantages: Filigree and solid parts cannot be de-powdered together. Filigree parts are also generally difficult to de-powder and tend to be damaged. Furthermore, the de-powdering methods known to date lack reproducibility. Both the de-powdering result and the arising damage to the de-powdered parts are random in nature. For example, the de-powdering of blind holes and nestings are not predictable and repeatable and de-powdering also takes place in positions where no de-powdering is desired. Furthermore, hazardous powders can hardly be handled with these methods and a sorting of the parts is not possible during the process.

In contrast, the de-powdering by means of the fluidization according to the invention through vibration has a number of advantages. There is no damage, filigree and solid parts can be de-powdered together and even filigree parts can be de-powdered without problems. The parts to be de-powdered can furthermore be sorted during the process. The handling of hazardous powders is greatly improved. The de-powdering mainly takes place at the outer surfaces of the parts and is reproducible. The degree of de-powdering of the parts can already be roughly determined before the de-powdering and fluctuates by only +/−3% after several tests. The de-powdering with the apparatus or according to the method of the present invention takes place predominantly at the outer surfaces of parts. In this respect, a degree of de-powdering >95% is generally and repeatedly achieved at the outer surfaces. Powder in blind holes, cavities, nestings or fine grid structures, on the other hand, is not removed. This indeed leads to a (small) loss of material when recovering the excess powder, but is nevertheless to be regarded as an advantage of the present invention since a higher quality of the recovered powder is achieved in this way. Residual powder that is e.g. located between fine grid structures has namely already been subjected to considerable thermal stress during the additive manufacturing process and should therefore no longer be used.

The entirety formed in the 3D printing apparatus from the additively manufactured objects and the surrounding powder cake of excess material is also referred to as a build job in this context. According to one embodiment, a build job is inserted as a whole into the processing space. The build job can in this respect be transferred directly from the 3D printing apparatus or by means of a transport box into the apparatus of the present invention.

If the apparatus according to the present invention comprises a transport chute, the powder cake with the additively manufactured objects or the build job as a whole can be transferred via the transport chute into the processing space of the apparatus.

According to a further embodiment, the objects are indeed also additively manufactured objects from any desired powder bed-based 3D printing method; however, the objects have already been removed from the powder cake. The particles of the particle bed can then substantially consist not of excess powder bed material, but of one or more other fluidizable powders that are suitable, for example, for de-powdering or processing the object surfaces. For example, an additively manufactured part made of PA12 (poly(dodecano-12-lactam), a polyamide) can be placed together with a particle bed of white fused alumina powder (aluminum oxide particles) in an apparatus according to the invention. Due to their lower density, the PA12 parts float on the surface of the fluidized bed and are de-powdered by the swirling white fused alumina (so-called “floating de-powdering”). According to an embodiment example, a mixture of fluidizable fine white fused alumina (average particle size 53-90 μm) with a small amount of coarse white fused alumina (1400-2000 μm) is used. The coarse white fused alumina particles are likewise conveyed upwards, swirled up there and thus contribute to a further improved de-powdering of the PA12 parts.

The above-explained processes for separating and/or de-powdering objects, in particular additively manufactured parts, indeed represent advantageous embodiments; however, the present invention is by no means limited to these specific applications. Further application possibilities, for example, consist in conditioning, homogenizing, mixing and transporting particle beds and in the targeted surface treatment of objects included therein. An exemplary application of the fluidization according to the invention is an enrichment of a powder with gas (e.g. air), for example, to change its flowability.

The present invention can be used in a batch operation in which the apparatus is filled with a single batch of a particle bed, a fluidization of the bed, possibly in a time sequence of different fluidized bed states, then takes place and, after completion of the fluidization, the particles, including possibly included objects, are removed from the apparatus.

However, it is also possible for the apparatus to be used as a system in continuous operation. In this case, it is advantageous if the apparatus comprises at least two transport chutes so that the particle material to be fluidized can be fed via a first chute and the treated particle material can leave the apparatus via a second chute.

The present invention will be described in the following purely by way of example with reference to an advantageous embodiment and to the enclosed drawing. There is shown:

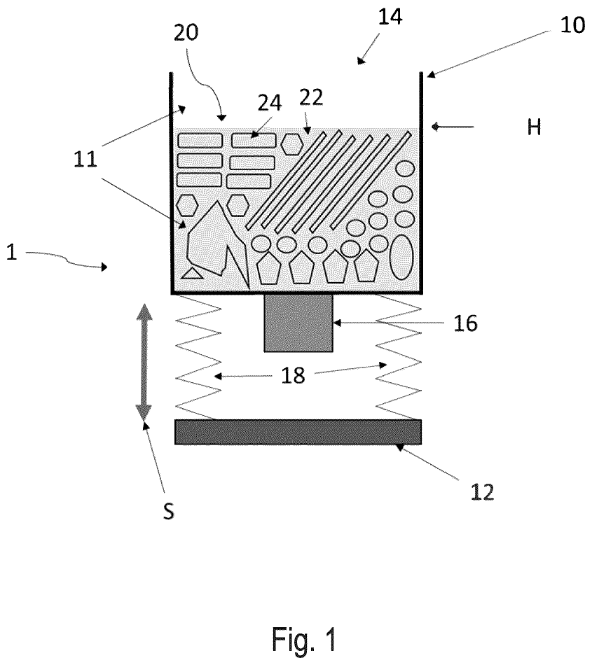

FIG. 1 a sectional view of an apparatus according to the invention for fluidizing particles present as a particle bed in the filled state.

The apparatus 1 shown in FIG. 1 has a container 10 and a horizontal base plate 12 arranged below it. The container 10 is movably supported in a vertical oscillation direction S relative to the base plate 12. Specifically, the container 10 is connected to the base plate 12 in a vertically flexible manner via springs 18. An oscillation generator 16 by means of which the container 10 can be set into a vertical oscillation relative to the base plate is attached to the lower side of the container 10. The oscillation generator 16 is connected to a control unit, not shown, by which the frequency and/or amplitude of the oscillation can be set.

Furthermore, the container 10 defines a processing space 11 for receiving a particle bed 22. At its upper side, the container 10 has an opening 14 via which the processing space 11 enclosed by the container 10 can be filled with the particle bed 22 and emptied. A cover (not shown) can be provided to close the opening 14. The cover can also be only partly closed, e.g. by means of segments or a variable cover opening, to influence the dynamics of the fluidized particle bed by the buildup and/or the control of a counter-pressure in the processing space 11.

In the embodiment example shown, the container 10 is not only filled with a particle bed 22, but also with objects 24 to be processed, and indeed up to a filling height H. More specifically, the filling is a complete build job 20 or parts of a complete build job 20 that results, for example, from a previously performed powder bed-based 3D printing method and that consists of a powder cake 22, which is formed from excess powder bed material, and various printed parts 24 of different sizes included therein, wherein the smallest parts 24 have a length or a diameter of approximately 1 cm. The powder cake 22 is formed from particles that have an average particle size between 10 μm and 250 μm.

FIG. 1 shows the state before the start of the fluidization in which no vertical sorting of the parts 24 by size has yet taken place. The apparatus 1 does not comprise any means for introducing a fluid, i.e. it is an apparatus for a fluid-free fluidization of a particle bed. As soon as the oscillation generator 16 is activated, the container 10 begins to perform a vertical oscillation in the direction S relative to the base plate 12. By means of the control unit provided for this purpose, a frequency and amplitude of the oscillation is set that is so high that it leads to a fluidization of the particle bed 22. The frequency and/or the amplitude of the oscillation can be successively increased via the control unit until the desired state of the fluidized bed, e.g. a slugging fluidized bed, is achieved. During the fluidization of the particle bed, a vertical sorting of the printed parts 24 by weight or density can take place when setting suitable parameters, wherein the lighter the parts 24 are, the higher they rise in the fluidized bed formed. At the same time, due to the relative movement of the fluidized particles and the printed parts 24 to one another during the fluidization, a de-powdering of the printed parts 24 takes place that are in this respect freed from adhering powder residues at their outer surfaces. On the other hand, blind holes, cavities, nestings and fine grid structures present in the printed parts 24 are not de-powdered. After a sorting by size and a de-powdering have taken place, the frequency and the amplitude of the oscillation are reduced via the control unit until the vertical oscillation comes to a standstill. As soon as the container 10 is at rest again, the particle bed 22, on the one hand, and the sorted and de-powdered parts 24, on the other hand, can be removed therefrom.

1-20. (canceled)

21. An apparatus for fluidizing particles present as a particle bed, said apparatus comprising:
at least one vertically movably supported container that defines a processing space for receiving the particle bed;
an oscillation generator by which the container can be set into a vertical oscillation during operation; and
a control unit for setting the frequency and/or amplitude of the vertical oscillation.

22. The apparatus according to claim 21,
wherein the container has a first opening for introducing the particle bed into the processing space and/or wherein the container has a second opening for removing material from the processing space.

23. The apparatus according to claim 22,
wherein a sieve unit is provided in the region of the second opening.

24. The apparatus according to claim 21,
wherein a powder mixing unit is arranged below the container.

25. The apparatus according to claim 21,
wherein a suction unit connected to the container is provided.

26. The apparatus according to claim 21,
wherein at least one wall of the container is displaceable so that the volume and/or the base surface of the processing space is/are changeable and/or wherein the base of the container is inclinable and/or is displaceable in a vertical direction.

27. The apparatus according to claim 21,
wherein the container is configured such that the processing space can be tilted or inclined.

28. The apparatus according to claim 21,
wherein at least one of a camera and a sensor is provided for monitoring the processing space.

29. The apparatus according to claim 21,
wherein a non-volatile data memory, which includes an internal parameter database, is connected to the control unit.

30. A method of operating an apparatus for fluidizing particles present as a particle bed, said apparatus comprising at least one vertically movably supported container that defines a processing space for receiving the particle bed; an oscillation generator by which the container can be set into a vertical oscillation during operation; and a control unit for setting the frequency and/or amplitude of the vertical oscillation, wherein the particles present as the particle bed and are converted into a fluidized bed by fluidization and energy required for this purpose is at least partly introduced via the oscillation generator in that the oscillation generator causes a vertical oscillation of the container whose frequency and amplitude are set by means of the control unit.

31. The method according to claim 21,
wherein the fluidization of the particle bed is caused solely by the oscillation and not by an introduction of a fluid into the container.

32. The method according to claim 31,
wherein the fluidization is supported by an additional introduction of gas into the container.

33. The method according to claim 30,
wherein the fluidization takes place by converting the particle bed from a fixed bed into a homogeneous fluidized bed, from a homogeneous fluidized bed into an inhomogeneous fluidized bed, from an inhomogeneous fluidized bed into a turbulent fluidized bed and/or from an inhomogeneous fluidized bed into a slugging fluidized bed or in an ascending or descending order of these fluidized bed states.

34. The method according to claim 30,
wherein the frequency of the oscillation is between 2 and 200 Hz and/or the amplitude is between 0.01 and 25 mm.

35. The method according to claim 30,
wherein objects included in the particle bed are separated from particles.

36. The method according to claim 30,
wherein objects included in the particle bed are de-powdered by freeing them from particles adhering to their surfaces.

37. The method according to claim 30,
wherein objects included in the particle bed are sorted by weight in the vertical direction.

38. The method according to claim 30,
wherein the container is filled with a medium that has a greater density than the objects.

39. The method according to claim 30,
wherein the composition of the particle bed is changed by removing or adding other particle types.

40. The method according to claim 30,
wherein additional powder is introduced into the container during the fluidization.

41. The apparatus according to claim 21, wherein the apparatus is further configured to fluidize objects included in the particle bed.
